(19) United States
(12) Patent Application Publication
(10) Pub. No.: US 2018/0093271 A1
(43) Pub. Date: Apr. 5, 2018

(54) Microdevice for Capturing Particles, and Method for Capturing, Concentrating, or Separating Particles Using the Same

(71) Applicants: The University of Tokyo, Tokyo (JP); ARKRAY, Inc., Kyoto (JP)

(72) Inventors: Teruo Fujii, Tokyo (JP); Soo Hyeon Kim, Tokyo (JP); Hiroshi Ito, Kyoto-shi (JP)

(73) Assignees: The University of Tokyo, Tokyo (JP); ARKRAY, Inc., Kyoto (JP)

(21) Appl. No.: 15/720,515

(22) Filed: Sep. 29, 2017

(30) Foreign Application Priority Data
Sep. 30, 2016 (JP) 2016-193796
Sep. 29, 2017 (JP) 2017-189511

(51) Int. Cl. B01L 3/00; G01N 1/40; G01N 15/14; B03C 5/00

(52) U.S. Cl. CPC B01L 3/502761; G01N 1/40; G01N 2015/0065; B03C 5/005; G01N 2001/4038; G01N 15/1484

(57) ABSTRACT

The present disclosure relates to a microdevice for capturing particles from a sample, a method for capturing particles from a sample, and a method for concentrating or separating particles using the same.

### BACKGROUND OF THE INVENTION

### 1. Field of the Invention

The present disclosure relates to a microdevice for capturing particles from a sample, a method for capturing particles from a sample, and a method for concentrating or separating particles using the same. In one or more embodiments, the microdevice, the capturing method, the concentrating method, and the separating method of the present disclosure can be used to capture, concentrate, or separate cells in a sample.

### 2. Description of Related Art

Liquid containing various particles such as cells is concentrated, or particles are collected from the liquid. For example, a micro-chamber array apparatus may capture an object to be examined, by using dielectrophoresis (DEP) and disrupt an object to be examined, by using cell-disruption (electroporation, EP) in a single well. Also, by using dielectrophoresis, liquid containing microparticles may be divided into a concentrated liquid having a high concentration of microparticles and a diluted liquid having a low concentration of microparticles.

### SUMMARY OF THE INVENTION

For the purposes of early detection and diagnosis of diseases, academic research on diseases, and the like, particles (for example, cells) and various components in a specimen collected from a living body are analyzed. For example, blood contains medically important cells such as rare cells (e.g., circulating tumor cells (CTCs) and immune cells). For example, CTCs are cells that separate from primary tumor tissues or metastatic tumor tissues and invade blood, and thus it has been reported that the number of CTCs in blood relates to the possibility of cancer metastasis and prognosis. Thus, there is demand to accurately analyze these cells.

However, rare cells such as the above-described CTCs are present in a sample in an extremely small amount such as about several cells. Therefore, for the convenience of use for analysis, rare cells need to be collected in a state in which particles included in the sample are concentrated. When such a sample is concentrated, loss of cells caused by centrifugation, which is a common concentrating method, is a very significant problem. Also, when centrifugation is used to concentrate the sample, the degree of loss that occurs is high between workers, experiments, or the like, and thus centrifugation is problematic for reproducibility.

In one or more embodiments, the present disclosure relates to a device and a method with which particles such as rare cells in a sample can be captured precisely, and, in some embodiments, further relates to a device and a method with which particles such as rare cells in a sample can be concentrated.

In one aspect, the present disclosure relates to a microdevice for capturing particles from a sample through dielectrophoresis, and the microdevice includes an inlet, an outlet, and a flow channel chamber that connects the inlet and the outlet, in which the flow channel chamber has an enlarged portion in which a cross-sectional area of a flow channel enlarges, and the flow channel chamber is provided with an electric field generation means disposed at least in the enlarged portion or the vicinity of the enlarged portion.

In some embodiments, the cross-sectional area of the flow channel may increases from an upstream side of the microdevice to a downstream side of the microdevice. In some embodiments, the cross-sectional area of the flow channel may increase from the inlet towards the outlet.

In another aspect, the present disclosure relates to a method for capturing particles from a sample in a flow channel chamber of a microdevice, the microdevice being the above-described microdevice for capturing particles, the method including causing the electric field generation means of the microdevice to generate an electric field, and introducing the sample into the flow channel chamber from the inlet of the microdevice.

In another aspect, the present disclosure relates to a method for concentrating, separating, observing, or collecting particles in a sample, the method including capturing particles from a sample with the method for capturing particles of the present disclosure.

According to the present disclosure, in one aspect, it is possible to precisely capture particles such as rare cells from a sample. Also, in one aspect, the present disclosure may exhibit the effect of being able to capture or collect particles such as rare cells from a sample with a high reproducibility while reducing loss. Also, in one aspect, the present disclosure may exhibit the effect of being able to concentrate, separate, observe, or collect particles such as rare cells in a sample.

### BRIEF DESCRIPTION OF THE DRAWINGS

FIG. 1 is a schematic diagram of one example of a microdevice of the present disclosure. In FIG. 1, (A) is a top view of a microdevice 1, (B) is a cross-sectional view taken along a direction I-I in (A), and (C) is a cross-sectional view taken along a direction II-II in (B).

FIG. 2 is one example of an image showing distribution of captured cancer cells in Example 2 and Comparative Example 3.

FIG. 3 is one example of an image showing distribution of captured cancer cells and white blood cells in Example 7.

### DETAILED DESCRIPTION OF THE INVENTION

In one aspect, when a non-uniform electric field is generated in a flow channel chamber having an enlarged portion in which a cross-sectional area of a flow channel enlarges from the upstream side toward the downstream side and a cell liquid is introduced into the flow channel chamber from the upstream side of the flow channel chamber in this state, cells that flow at a reduced flow speed in the enlarged portion may be captured with a dielectrophoretic force, and cells can be concentrated.

Also, in one aspect, the efficiency of concentrating cells may be increased by utilizing the dielectrophoretic force of cells and the flow channel chamber having the enlarged portion in which the cross-sectional area of the flow channel enlarges.

The mechanism with which particles such as cells may be precisely captured by the present disclosure is not clear, but it is inferred as follows.

When a sample is introduced into a flow channel chamber having an enlarged portion, the flow velocity of the sample decreases due to enlargement of the cross-sectional area of the flow channel in the enlarged portion. It is conceivable that as a result, a dielectrophoretic force may be applied to particles in the sample in a state in which the flow velocity of the sample is reduced, and thus particles may be captured easily. In particular, it is conceivable that by forming the enlarged portion obtained by enlarging the height of the flow channel chamber in the height direction from a portion of the flow channel chamber that has a low height and is located in front of the enlarged portion, it is possible to reduce the flow velocity of particles in a state in which particles are close to the electric field generation means (for example, electrodes) (that is, after a state is achieved in which the dielectrophoretic force that the particles receive is high), and it is thereby possible to further increase the particle capture ratio.

In one aspect, the sample described herein may be a sample obtained from a human, patient or animal. In some embodiments, the sample may be blood, plasma, saliva or serum, In additional embodiments, the sample contains a mammalian or human cell.

A distribution of flow velocities occurs in the flow channel such that the flow velocity is lower on the wall surface sides (for example, the upper surface side and the bottom surface side) of the flow channel compared to the central portion of the flow channel, and thus, by reducing the height of the flow channel in front of the enlarged portion, a state is created in which particles are physically close to the bottom surface side such that particles reach the enlarged portion or the vicinity thereof in a state in which the particles are close to the bottom surface side on which the flow velocity is low. Herein, the “vicinity” of an enlarged portion refers to a portion within 1, 5, 10, 20, 30, 40, 50, 60, 70, 80, 90, 100, 200, 300, 400 or 500 μm from the enlarged portion. The “vicinity” of a bottom surface refers to a portion within 1, 5, 10, 20, 30 or 40 μm from the bottom surface. Furthermore, because the dielectrophoretic force has a stronger effect the closer the distance to the electric field generation means is, a strong dielectrophoretic force is applied to particles that are close to the bottom surface by installing the electric field generation means on the bottom surface of the flow channel. In such a state, when the cross-sectional area of the flow channel in the flow channel chamber is enlarged, the flow velocity of the whole sample decreases and the flow velocity of the sample in the vicinity of the bottom surface further decreases. As a result, it is possible to efficiently capture particles. That is, compared to a configuration in which the enlarged portion is not provided, the configuration in which the enlarged portion is provided has a high capture efficiency and enlargement in the height direction more effectively achieves the above-described effect than enlargement in the width direction.

However, the present disclosure need not be interpreted as being limited to these mechanisms.

Microdevice

In one aspect, the present disclosure relates to a microdevice (the microdevice of the present disclosure) for capturing particles in a sample through dielectrophoresis. The microdevice of the present disclosure includes an inlet, an outlet, and a flow channel chamber that connects the inlet and the outlet, in which the flow channel chamber has an enlarged portion in which the cross-sectional area of the flow channel enlarges, and the flow channel chamber is provided with an electric field generation means disposed at least in the enlarged portion or the vicinity of the enlarged portion.

According to the microdevice of the present disclosure, in one or more embodiments, particles such as rare cells in a sample may be captured. Also, according to the microdevice of the present disclosure, in one or more embodiments, it is possible to efficiently concentrate particles in a sample. In one or more embodiments, the microdevice of the present disclosure enables observation, analysis, or collection of captured or concentrated particles.

The flow channel chamber in the microdevice of the present disclosure connects the inlet and the outlet, and may eject, from the outlet, a sample that is introduced from the inlet. Also, particles captured in the flow channel chamber may be collected from the flow channel chamber by introducing a collection liquid from the inlet or the outlet.

The flow channel chamber in the microdevice of the present disclosure has an enlarged portion in which the cross-sectional area of the flow channel enlarges from the inlet toward the outlet. Accordingly, in the microdevice of the present disclosure, in one or more embodiments, the flow velocity of a sample (the speed of particles) may be rapidly reduced in a state in which particles in the sample that is introduced into the flow channel chamber are close to the electric field generation means (for example, electrodes), and a dielectrophoresis force generated by the electric field generation means in the flow channel chamber may be applied to particles whose speed is reduced. Thus, according to the microdevice of the present disclosure, in one or more embodiments, it is possible to precisely capture particles from a sample.

In one or more embodiments, in the enlarged portion, the cross-sectional area of the flow channel enlarges in a height direction or a width direction, or in both the height direction and the width direction with respect to the bottom surface of the flow channel chamber. In one or more embodiments, enlargement of the flow channel in the height direction may be achieved by increasing the height of the upper surface of the flow channel chamber. In one or more embodiments, enlargement of the flow channel in the height direction may be achieved by enlarging the flow channel in the height direction at 90 degrees (in the perpendicular direction to a direction into which the sample flows) or at approximately 90 degrees, enlarging the flow channel in a linear manner, in a gradual manner, or in a curved manner in the height direction from the inlet toward the outlet, or enlarging the flow channel with a combination of these manners. In one or more embodiments, gradual enlargement includes stepwise (including single step) enlargement. In one or more embodiments, enlargement of the flow channel in the width direction may be achieved by increasing the width of the flow channel chamber. In one or more embodiments, enlargement of the flow channel in the width direction may be achieved by enlarging the width of the flow channel at 180 degrees (in the horizontal direction with respect to a direction into which the sample flows) or at approximately 180 degrees, enlarging the width in a linear manner, in a gradual manner, or in a curved manner in the width direction from the inlet toward the outlet, or enlarging the width with a combination of these manners. In one or more embodiments, gradual enlargement includes stepwise (including single step) enlargement.

In the present disclosure, when the enlarged portion enlarges in a linear manner or in a curved manner in the height direction and/or the width direction from the inlet toward the outlet, a region extending from a portion at which the enlargement starts to a portion having the maximum height and/or a portion having the maximum width is referred to as “enlarged portion”.

From the viewpoint of the enlarged portion being capable of further reducing the bottom area of the flow channel chamber, and as a result, being capable of improving the concentration factor, or further reducing an observation surface when particles are observed using the microdevice, in some embodiments, the flow channel enlarges in the height direction.

In one or more embodiments, an example of the enlarged portion includes a portion in which the cross-sectional area of the flow channel that is orthogonal to a straight line direction between the inlet and the outlet (the direction into which the sample flows) enlarges. In the present disclosure, “the cross-sectional area of the flow channel (flow channel cross-sectional area)” refers to the area of the cross section of the flow channel chamber in a direction that is orthogonal to the direction into which the sample flows. In one or more embodiments, enlargement of the cross-sectional area is achieved by the flow channel cross-sectional area of the flow channel chamber being larger than the flow channel cross-sectional area that is located in front of the enlarged portion. The flow channel cross-sectional area need only be determined as appropriate in accordance with the captured particles, the sample, the flow velocity, and the like. In one or more embodiments, the flow channel cross-sectional area of flow channel chamber is about 1.5 times or more, 2 times or more, 2.5 times or more, 3 times or more, 3.5 times or more, 4 times or more, 4.5 times or more, 5 times or more, 5.5 times or more, or 6 times or more the flow channel cross-sectional area that is located in front of the enlarged portion. In one or more embodiments, the flow channel cross-sectional area of flow channel chamber is about 2 times or less, 2.5 times or less, 3 times or less, 3.5 times or less, 4 times or less, 4.5 times or less, 5 times or less, 5.5 times or less, 6 times or less or 7 times or less of the flow channel cross-sectional area that is located in front of the enlarged portion. Thus, in one or more embodiments, a flow channel cross-sectional area ratio between the enlarged portion and the portion that is located in front of the enlarged portion ([the flow channel cross-sectional area of the enlarged portion]/[the flow channel cross-sectional area of the portion that is located in front of the enlarged portion]) is about 1.5 or more, 2 or more, 2.5 or more, 3 or more, 3.5 or more, 4 or more, 4.5 or more, 5 or more, 5.5 or more, or 6 or more, and/or 10 or less, 9 or less, 8 or less, or 7 or less. As used herein, the term “about” may refer to a range of values that are similar to the stated reference value. In certain embodiments, the term “about” refers to a range of values that fall within 15, 10, 9, 8,7, 6, 5, 4, 3, 2, 1 percent or less of the stated reference value. In the present disclosure, “the flow channel cross-sectional area of the enlarged portion” refers to the flow channel cross-sectional area having the maximum flow channel cross-sectional area in the enlarged portion. In the present disclosure, “the flow channel cross-sectional area of a portion that is located in front of the enlarged portion” refers to the flow channel cross-sectional area that is located on the upstream side of the enlarged portion and just before the flow channel cross-sectional area changes (i.e., enlarges).

Embodiment in which Enlarged Portion Enlarges in Height Direction with Respect to Bottom Surface of Flow Channel Chamber

In an embodiment in which the enlarged portion enlarges in the height direction with respect to the bottom surface of the flow channel chamber, a ratio (He/Hb) between a height (He) of the enlarged portion and a height (Hb) of the portion that is located in front of the enlarged portion (enlargement change point) need only be determined as appropriate in accordance with the captured particles, the sample, the flow velocity, and the like, and in one or more embodiments, the ratio (He/Hb) is about 1.5 or more, and from the viewpoint of reducing the flow velocity and further increasing the capture ratio in the enlarged portion, the ratio (He/Hb) is about 1.5 or more, 2 or more, 2.5 or more, 3 or more, 3.5 or more, 4 or more, 4.5 or more, 5 or more, 5.5 or more, or 6 or more. Also, in one or more embodiments, the upper limit of the above-described ratio (He/Hb) is about 10 or less, 9 or less, 8 or less, or 7 or less. In the present disclosure, “the height (He) of the enlarged portion” refers to the height of a portion of the flow channel chamber having the maximum height in the enlarged portion. In the present disclosure, “the height (Hb) of the portion that is located in front of the enlarged portion” refers to the height of the flow channel chamber that is located on the upstream side of the enlarged portion and just before the flow channel cross-sectional area increases.

The height (He) of the enlarged portion is about 100 μm or more, and from the viewpoint of reducing the flow velocity in the enlarged portion, in one or more embodiments, the height (He) is 100 μm or more, 200 μm or more, 300 μm or more, 400 μm or more, 500 μm or more, or 600 μm or more. In one or more embodiments, the height of the enlarged portion is about 1000 μm or less, 900 μm or less, 800 μm or less, or 700 μm or less.

From the viewpoint of reducing the flow velocity and further increasing the capture ratio in the enlarged portion, in one or more embodiments, the height (Hb) of the portion that is located in front of the enlarged portion is about 200 μm or less, 150 μm or less, 100 μm or less, 50 μm or less, or 40 μm or less. In one or more embodiments, the height (Hb) of the portion that is located in front of the enlarged portion is about 20 μm or more or 30 μm or more.

From the viewpoint of further increasing the capture ratio, in one or more embodiments, the width of the flow channel chamber in this embodiment is about 0.05 mm or more, 0.1 mm or more, or 0.5 mm or more, and from the viewpoint of concentrating particles, the width is about 50 mm or less, 40 mm or less, 30 mm or less, 20 mm or less, 10 mm or less, 9 mm or less, 8 mm or less, 7 mm or less, 6 mm or less, 5 mm or less, 4 mm or less, 3 mm or less, 2 mm or less, or 1 mm or less. In the present disclosure, the width of the flow channel chamber refers to the length of the flow channel in a direction that is orthogonal to the direction into which the sample flows.

The height (He) of the enlarged portion, the height (Hb) of the portion that is located in front of the enlarged portion, the width of the flow channel chamber, and the like need only be determined as appropriate in accordance with the captured particles, the sample, the flow velocity, and the like.

Embodiment in which Enlarged Portion Enlarges in Width Direction with Respect to Bottom Surface of Flow Channel Chamber

In an embodiment in which the enlarged portion enlarges in the width direction with respect to the bottom surface of the flow channel chamber, in one or more embodiments, a ratio (We/Wb) between a width (We) of the enlarged portion and a width (Wb) of the portion that is located in front of the enlarged portion is about 1.5 or more, and from the viewpoint of reducing the flow velocity and further increasing the capture ratio in the enlarged potion, the ratio (We/Wb) is about 1.5 or more, 2 or more, 2.5 or more, 3 or more, 3.5 or more, 4 or more, 4.5 or more, 5 or more, 5.5 or more, or 6 or more. Also, in one or more embodiments, the upper limit of the above-described ratio (We/Wb) is about 10 or less, 9 or less, 8 or less, or 7 or less. In the present disclosure, “the width (We) of the enlarged portion” refers to the width of a portion of the flow channel chamber having the maximum width in the enlarged portion. In the present disclosure, “the width (Wb) of the portion that is located in front of the enlarged portion” refers to the width of the flow channel chamber that is located on the upstream side of the enlarged portion and just before the flow channel cross-sectional area increases.

The width (We) of the enlarged portion is 0.075 mm or more, and from the viewpoint of reducing the flow velocity and further increasing the capture ratio in the enlarged portion, in one or more embodiments, the width (We) is about 0.1 mm or more, 0.2 mm or more, 0.3 mm or more, 0.4 mm or more, 0.5 mm or more, 1 mm or more, 2 mm or more, 3 mm or more, 4 mm or more, 5 mm or more, 6 mm or more, 7 mm or more, 8 mm or more, 9 mm or more, or 10 mm or more. In one or more embodiments, the width (We) of the enlarged portion is about 500 mm or less, 400 mm or less, 300 mm or less, 200 mm or less, 100 mm or less, 90 mm or less, 80 mm or less, 70 mm or less, 60 mm or less, 50 mm or less, 40 mm or less, 30 mm or less, or 20 mm or less.

From the viewpoint of reducing the flow velocity and further increasing the capture ratio in the enlarged portion, in one or more embodiments, the width (Wb) of the portion that is located in front of the enlarged portion is about 50 mm or less, 40 mm or less, 30 mm or less, 20 mm or less, 10 mm or less, 9 mm or less, 8 mm or less, 7 mm or less, 6 mm or less, 5 mm or less, 4 mm or less, 3 mm or less, 2 mm or less, or 1 mm or less. In one or more embodiments, the width (Wb) of the portion that is located in front of the enlarged portion is about 0.05 mm or more, 0.1 mm or more, or 0.5 mm or more.

From the viewpoint of further increasing the particle capture ratio by further reducing the flow velocity in the enlarged portion in a state in which particles are close to the bottom surface of the flow channel chamber, in one or more embodiments, the height of the flow channel chamber from the inlet side to the enlargement change point is about 200 μm or less, 150 μm or less, 100 μm or less, 50 μm or less, 40 μm or less, 30 μm or less, or 20 μm or less. In one or more embodiments, the height of the flow channel chamber is about 20 μm or more or 30 μm or more.

There is no particular limitation on the number of enlarged portions formed in the flow channel chamber, and at least one enlarged portion need only be formed.

In one or more embodiments, from the viewpoint of further increasing the capture ratio, the length of the flow channel chamber is about 0.05 mm or more, 0.1 mm or more, 0.5 mm or more, or 1 mm or more, and from the viewpoint of concentrating particles, the length is about 100 mm or less, 50 mm or less, 40 mm or less, 30 mm or less, 20 mm or less, 10 mm or less, 9 mm or less, 8 mm or less, 7 mm or less, 6 mm or less, 5 mm or less, 4 mm or less, 3 mm or less, or 2 mm or less. In the present disclosure, the length of the flow channel chamber refers to the length of the flow channel in the direction into which the sample flows.

In one or more embodiments, the volume (capacity) of the flow channel chamber is about 10 pl or more, 100 pl or more, 1 nl or more, 10 nl or more, 0.1 μl or more, 0.2 μl or more, 0.3 μl or more, 0.4 μl or more, 0.5 μl or more, 0.6 μl or more, 0.7 μl or more, 0.8 μl or more, 0.9 μl or more, or 1 μl or more, and/or 10 ml or less, 5 ml or less, 1 ml or less, 0.5 ml or less, 0.3 ml or less, 0.1 ml or less, 90 μl or less, 80 μl or less, 70 μl or less, 60 μl or less, 50 μl or less, 40 μl or less, 30 μl or less, 20 μl or less, or 10 μl or less.

The width (We) of the enlarged portion, the width (Wb) of the portion that is located in front of the enlarged portion, the length of the flow channel chamber, the volume of the flow channel chamber, and the like need only be determined as appropriate in accordance with the captured particles, the sample, the flow velocity, and the like.

From the viewpoint of further increasing the particle capture ratio and making observation of captured particles easy, the bottom surface of the flow channel chamber is, for example, a flat surface.

The flow channel chamber is provided with an electric field generation means for causing an electric field. In one or more embodiments, the microdevice of the present disclosure is capable of generating a non-uniform electric field by applying an electric field to the electric field generation means disposed in the flow channel chamber and causing dielectrophoresis. From the viewpoint of further increasing the particle capture ratio, in one or more embodiments, it is sufficient that the electric field generation means is disposed at least in the enlarged portion or the vicinity thereof. In one or more embodiments, disposing the electric field generation means in the enlarged portion or the vicinity thereof is achieved by disposing the electric field generation means at a position that faces the enlarged portion when the enlarged portion has a shape such that one wall surface enlarges upward. From the viewpoint of further increasing the particle capture ratio and making observation of captured particles easy, the electric field generation means is, for example, disposed on the bottom surface of the flow channel chamber. From the viewpoint of further increasing the particle capture ratio by reducing the flow velocity in the enlarged portion in a state in which particles are close to the bottom surface of the flow channel chamber, the electric field generation means is, for example, disposed at least on the bottom surface of the flow channel chamber that faces the enlarged portion.

In one or more embodiments, an example of the electric field generation means is a counter electrode for dielectrophoresis. From the viewpoint of further increasing the particle capture ratio, in one or more embodiments, the bottom surface of the flow channel chamber is provided with a counter electrode for dielectrophoresis. The microdevice of the present disclosure is capable of generating a non-uniform electric field by applying an electric field to the counter electrode disposed on the bottom surface of the flow channel chamber, and causing dielectrophoresis. In one or more embodiments, the electrodes need only be disposed at least near the enlarged portion, and from the viewpoint of further increasing the particle capture ratio, the electrodes are disposed on the entire bottom surface of the flow channel chamber from the upstream side to the downstream side. In one or more embodiments, the electrodes may be disposed on the bottom surface of the inner wall surface of the flow channel chamber.

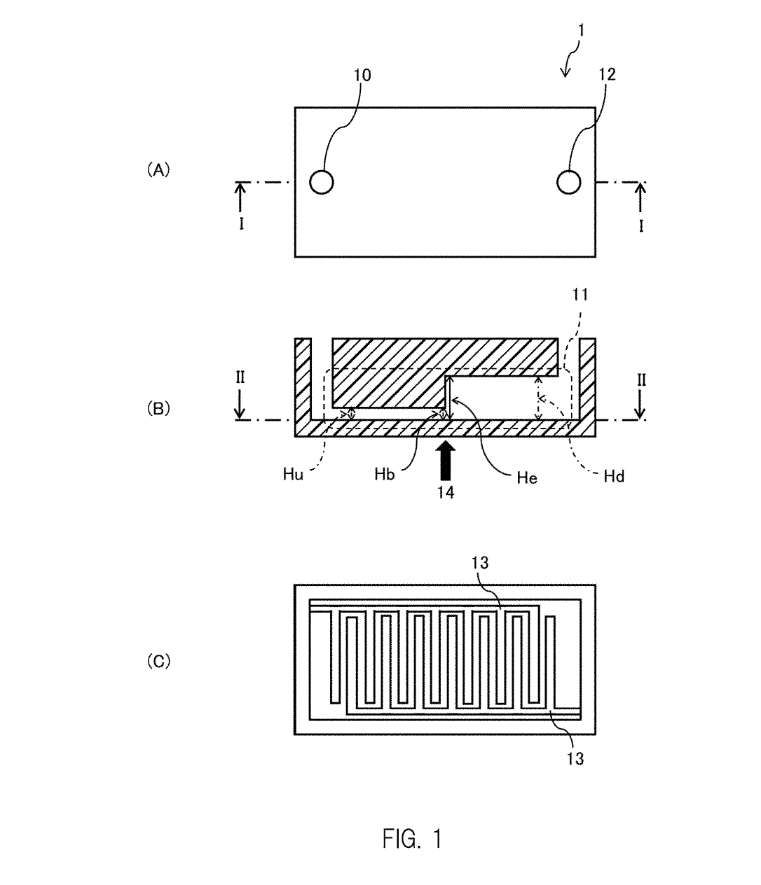

There is no particular limitation on the embodiment of the electrodes, and in one or more embodiments, an example of the electrode is a comb electrode (interdigital electrode). In one or more embodiments, as shown in FIG. 1(C), the comb electrodes may be disposed such that longitudinal directions of electrode fingers of the comb electrodes are orthogonal to the straight line direction (the direction into which the sample flows) between the inlet and the outlet.

In one or more embodiments, the width of electrodes is about 0.1 μm or more, 0.5 μm or more, 1 μm or more, 2 μm or more, 3 μm or more, 4 μm or more, 5 μm or more, 6 μm or more, 7 μm or more, 8 μm or more, 9 μm or more, or 10 μm or more, and/or 5000 μm or less, 1000 μm or less, 900 μm or less, 800 μm or less, 700 μm or less, 600 μm or less, 500 μm or less, 400 μm or less, 300 μm or less, 200 μm or less, or 100 μm or less. The widths of electrodes may be equal to or different from each other. In the present disclosure, the width of electrodes refers to the length of electrodes in the direction into which the sample flows.

In one or more embodiments, the gap between electrodes is about 1 μm or more, 2 μm or more, 3 μm or more, 4 μm or more, 5 μm or more, 6 μm or more, 7 μm or more, 8 μm or more, 9 μm or more, or 10 μm or more, and/or 1000 μm or less, 900 μm or less, 800 μm or less, 700 μm or less, 600 μm or less, 500 μm or less, 400 μm or less, 300 μm or less, 200 μm or less, or 100 μm or less. In the present disclosure, the gap between electrodes refers to an interval (distance) between electrodes that are adjacent in the direction into which the sample flows.

In one or more embodiments, the thickness of the electrode is about 0.1 nm or more, 0.5 nm or more, 1 nm or more, 2 nm or more, 3 nm or more, 4 nm or more, 5 nm or more, 6 nm or more, 7 nm or more, 8 nm or more, 9 nm or more, or 10 nm or more, and/or 1000 nm or less, 900 nm or less, 800 nm or less, 700 nm or less, 600 nm or less, or 500 nm or less.

In one or more embodiments, the length of each electrode finger may be determined as appropriate in accordance with the width of the flow channel chamber. In one or more embodiments, the length of each electrode finger is about 10% or more, 20% or more, 30% or more, 40% or more, 50% or more, 60% or more, or 70% or more, and/or 100% or less, 95% or less, 90% or less, or 85% or less of the width of the flow channel chamber. From the viewpoint of further increasing the particle capture ratio, in one or more embodiments, the electrode fingers may be disposed entirely across the width of the flow channel chamber.

In one or more embodiments, examples of the material of the electrode include indium tin oxide (ITO), titanium, chromium, gold, platinum, ZnO (zinc oxide), fluorine-doped tin oxide (FTO), silver, copper, and conductive materials (conductive polymer and the like). In one or more embodiments, the electrodes may be transparent because the captured particles are easily observed or analyzed.

There is no particular limitation on the positions at which the inlet and the outlet are formed. In one or more embodiments, examples of the positions of the inlet and the outlet are side surfaces, an upper surface, or a lower surface of the microdevice.

There is no particular limitation on the material of the microdevice, and in one or more embodiments, examples of the material of the microdevice include glass, molten silica, and resins such as plastic. Examples of the plastic include polymethyl methacrylate (PMMA), polycarbonate, polystyrene, polytetrafluoroethylene (PTFE), polyether ether ketone (PEEK), and silicone. In one or more embodiments, the microdevice may be transparent because the captured particles are easily observed or analyzed.

Method for Manufacturing Microdevice

The microdevice of the present disclosure may be manufactured by forming electrodes on a substrate, and joining the substrate provided with the electrodes and a substrate provided with a flow channel chamber including an enlarged portion in which the cross-sectional area of the flow channel enlarges, for example. Thus, in another aspect, the present disclosure relates to a method for manufacturing a microdevice including forming electrodes on a substrate and joining the substrate provided with the electrodes and a substrate provided with a flow channel chamber including an enlarged portion in which the cross-sectional area of the flow channel enlarges from the upstream side toward the downstream side. In one or more embodiments, the substrates are joined so as to cover the electrodes formed on the substrate provided with the flow channel chamber.

In one or more embodiments, electrodes may be formed with a conventionally known method. In one or more embodiments, examples of the formation method include photolithography technology and printing technology such as screen printing, gravure printing, and flexographic printing.

In one or more embodiments, a flow channel may be formed with a conventionally known method. In one or more embodiments, examples of the formation method include cutting technology and casting technology.

Method for Capturing Particles

In another aspect, the present disclosure relates to a method for capturing particles in a sample (a capturing method of the present disclosure) including generating, in a flow channel chamber having an enlarged portion in which the cross-sectional area of a flow channel enlarges, an electric field for applying an dielectrophoretic force to particles, and introducing a sample containing particles into the flow channel chamber from the upstream side of the flow channel chamber. The time at which the electric field starts to be generated and the time at which the sample starts to be introduced into the inlet may be the same, or the electric field may start to be generated after the sample is introduced and before the sample reaches the enlarged portion. According to the capturing method of the present disclosure, because the sample containing particles is introduced from the upstream side of the flow channel chamber into the flow channel chamber having the enlarged portion in which the cross-sectional area of the flow channel enlarges from the upstream side toward the downstream side, particles may be precisely captured and easily concentrated. In one or more embodiments, the capturing method of the present disclosure may be performed using the microdevice of the present disclosure. Thus, in another aspect, the present disclosure relates to a method for capturing particles in a sample in a flow channel chamber of a microdevice, in which the microdevice is the microdevice of the present disclosure, and the method for capturing particles includes causing the electric field generation means of the microdevice to generate an electric field and introducing the sample into the flow channel chamber from the inlet of the microdevice.

In one or more embodiments, the electric field need only be generated in a portion corresponding to at least the enlarged portion. In one or more embodiments, the capturing method of the present disclosure includes generating an electric field for applying a dielectrophoretic force to particles on at least part of a bottom surface of the flow channel chamber or the entire bottom surface, and from the viewpoint of further increasing the capture ratio, the capturing method includes generating an electric field for applying a dielectrophoretic force to particles on the bottom surface of the flow channel chamber that corresponds to the enlarged portion, or generating an electric field for applying a dielectrophoretic force to particles on the entire bottom surface of the flow channel chamber.

In one or more embodiments, from the viewpoint of increasing treatment efficiency, the flow rate of the sample is about 1 μL/min or more, 2 μL/min or more, 3 μL/min or more, 4 μL/min or more, 5 μL/min or more, 6 μL/min or more, 7 μL/min or more, 8 μL/min or more, 9 μL/min or more, or 10 μL/min or more. Also, from the viewpoint of further increasing the capture ratio, the flow rate is about 1000 μL/min or less, 900 μL/min or less, 800 μL/min or less, 700 μL/min or less, 600 μL/min or less, 500 μL/min or less, 400 μL/min or less, 300 μL/min or less, 200 μL/min or less, or 100 μL/min or less.

In one or more embodiments, the amount of the sample introduced into the flow channel chamber may exceed the capacity of the flow channel chamber (i.e. such that the sample may overflow from the outlet). In one or more embodiments, the capturing method of the present disclosure includes introducing the sample in an amount exceeding the capacity of the flow channel chamber (for example including the sample so as to overflow from the outlet).

In one or more embodiments, the electric field may be generated by applying an alternating voltage to electrodes that are disposed on the bottom surface of the flow channel chamber.

In one or more embodiments, the applied voltage is about 0.1 V or more, 0.5 V or more, 1 V or more, 2 V or more, 3 V or more, 4 V or more, 5 V or more, 6 V or more, 7 V or more, 8 V or more, 9 V or more, or 10 V or more, and in one or more embodiments, the applied voltage is about 100 V or less, 90 V or less, 80 V or less, 70 V or less, 60 V or less, 50 V or less, 40 V or less, or 30 V or less.

The applied frequency need only be a frequency with which particles may be captured on the electrodes, and in one or more embodiments, the applied frequency is about 1 kHz or more, 5 kHz or more, 10 kHz or more, 50 kHz or more, 100 kHz or more, 200 kHz or more, 300 kHz or more, 400 kHz or more, 500 kHz or more, 600 kHz or more, 700 kHz or more, 800 kHz or more, 900 kHz or more, or 1 MH or more, and 100 MHz or less, 90 MHz or less, 80 MHz or less, 70 MHz or less, 60 MHz or less, 50 MHz or less, 40 MHz or less, 30 MHz or less, 20 MHz or less, or 10 MHz or less.

In one or more embodiments, the sample includes particles and a solvent (liquid) that suspends or disperses the particles.

In one or more embodiments in the present disclosure that are not particularly limited, an example of the particles is cells. In one or more embodiments, an example of the cells is rare cells such as CTCs. In one or more embodiments that are not particularly limited, examples of the rare cells include human colon cancer cells, human stomach cancer cells, human large bowel cancer cells, human lung cancer cells.

In one or more embodiments, from the viewpoint of suppressing a decrease in the occurrence of polarization in particles, reducing damage of flowing electric current on cells, or further increasing the capture ratio through dielectrophoresis, the solvent in which particles are suspended or dispersed is desired to have an electrical conductivity (conductance) that is as low as possible. From similar viewpoints, in one or more embodiments, the solvent may contain an electrolyte in a small amount. From similar viewpoints, if the particles are living cells, in one or more embodiments, the solvent may be or comprise a non-electrolytic isotonic solution such as a sucrose isotonic solution.

According to the capturing method of the present disclosure, in one or more embodiments, particles may be concentrated and analyzed. Thus, in another aspect, the present disclosure relates to a method for concentrating particles in a sample that includes capturing particles in a sample with the capturing method of the present disclosure. In one or more embodiments, the concentrating method of the present disclosure may include introducing a collection liquid into a flow channel chamber that captured particles, and collecting the particles captured in the flow channel chamber from the flow channel chamber. Thus, in still another aspect, the present disclosure relates to a method for collecting particles in a sample that includes capturing particles, in a flow channel chamber, in a sample with the capturing method of the present disclosure, introducing a collection liquid in the flow channel chamber, and collecting the particles captured in the flow channel chamber from the flow channel chamber. In yet another aspect, the present disclosure relates to a method for analyzing particles in a sample that includes capturing particles from a sample with the capturing method of the present disclosure.

According to the capturing method of the present disclosure, in one or more embodiments, particles may be concentrated and the captured particles may be observed or analyzed. Thus, in another aspect, the present disclosure relates to a method for observing or analyzing particles that includes capturing, in the flow channel chamber, particles in a sample with the capturing method of the present disclosure, and observing or analyzing the particles captured in the flow channel chamber. In one or more embodiments, particles may be observed through microscopy or the like. For example, particles may be analyzed with the microdevice of the present disclosure, and for example, after the particles are captured in the flow channel chamber, the particles may be analyzed in the flow channel chamber.

According to the microdevice and the capturing method of the present disclosure, in one or more embodiments, it is possible to capture, in different capture regions, particles that have different balances between the dielectrophoretic force received from the electric field and the resistance received from the liquid flow. That is, according to the microdevice and the capturing method of the present disclosure, in one or more embodiments, if the sample contains a plurality of types of particles (for example, if the sample contains two or more types of particles having different balances between the dielectrophoretic force received from the electric field and the resistance received from liquid flow), these particles may be captured in different capture regions. Thus, in still another aspect, the present disclosure relates to a method for separating particles in a sample, and the method for separating particles includes generating an electric field for applying a dielectrophoretic force to particles, in a flow channel chamber having an enlarged portion in which the cross-sectional area of a flow channel enlarges from the upstream side toward the downstream side, and introducing the sample containing particles into the flow channel chamber from the upstream side of the flow channel chamber. According to the separation method of the present disclosure, in one or more embodiments, it is possible to capture particles having different balances between the dielectrophoretic force received from the electric field and resistance received from liquid flow in different capture regions. According to the separation method of the present disclosure, in one or more embodiments, if the sample contains CTCs and white blood cells, white blood cells that receive a small resistance from liquid flow may be captured on the upstream side of the enlarged portion having a high cross-sectional flow velocity, and CTCs that receive a larger resistance from liquid flow than white blood cells may be captured in the vicinity of the enlarge portion having a low cross-sectional flow velocity. In one or more embodiments, with the separation method of the present disclosure, a plurality of types of particles included in a sample may be separated. Thus, in still another aspect, the present disclosure relates to a method for separating particles in a sample that includes generating an electric field for applying a dielectrophoretic force to particles, at least in the enlarged portion or the vicinity of the enlarged portion in a flow channel chamber having an enlarged portion in which the cross-sectional area of a flow channel enlarges from the upstream side toward the downstream side, introducing the sample containing particles into the flow channel chamber from the upstream side of the flow channel chamber, and separating a plurality of types of particles included in the sample.

One embodiment of the microdevice of the present disclosure will be described with reference to the drawings. FIG. 1 is a schematic diagram of one embodiment of the microdevice of the present disclosure. In FIG. 1, (A) is a top view of a microdevice 1, (B) is a cross-sectional view taken along a direction I-I in (A), and (C) is a cross-sectional view taken along a direction II-II in (B).

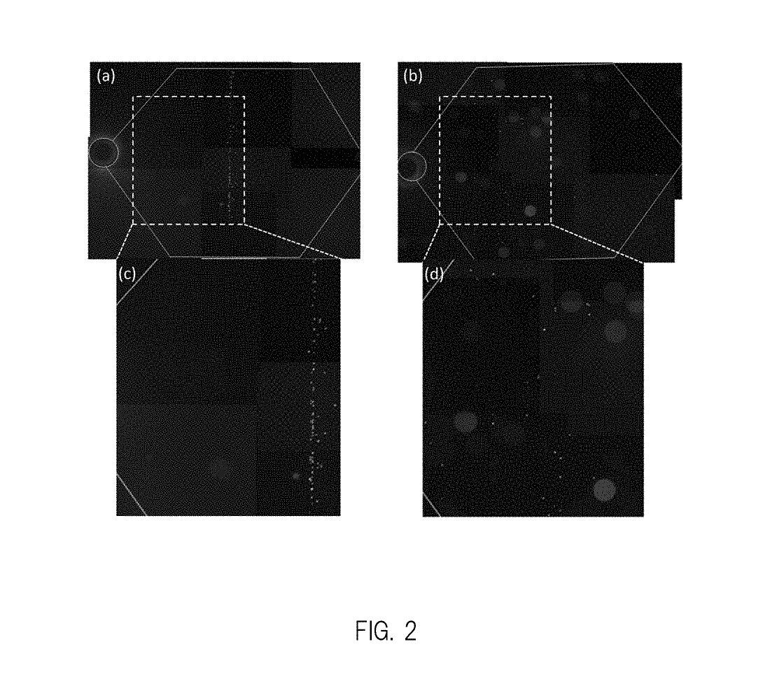

As shown in FIG. 1, the microdevice 1 has an inlet 10, a flow channel chamber 11, an outlet 12, and comb electrodes 13. The inlet 10 and the outlet 12 are formed on an upper surface of the microdevice 1, and are continuous with the flow channel chamber 11 formed in a longitudinal direction along a bottom surface of the microdevice 1. From the viewpoint of uniformly expanding a cell liquid introduced from the inlet 10 into the flow channel chamber 11 and/or inhibiting a gas phase from remaining on the wall surface of the flow channel chamber 11, as in FIG. 2 below, a portion of the flow channel chamber 11 that is in contact with the inlet 10 may be provided with a tapered portion which is widening from the inlet toward to the enlarged portion 14. A configuration in which no tapered portion is provided may be adopted.

The flow channel chamber 11 has an enlarged portion 14 in which the cross-sectional area of a flow channel enlarges in the height direction. In the microdevice 1 in FIG. 1, the enlarged portion 14 is formed in an approximately central portion of the flow channel chamber 11. A ratio (He/Hb) between a height (He) of the enlarged portion 14 and a height (Hb) at an enlargement change point is approximately 3. A height (Hu) of the flow channel chamber 11 on the upstream side of the enlarged portion 14 is equal to the height (Hb) at the enlargement change point. That is, in the microdevice 1 in FIG. 1, the height from the most upstream portion of the flow channel chamber 11 to the enlargement change point is approximately constant. Also, the height (He) of the enlarged portion 14 is equal to a height (Hd) of the flow channel chamber 11 on the downstream side of the enlarged portion 14. That is, in the microdevice 1 in FIG. 1, the height from the enlarged portion 14 to the most downstream portion of the flow channel chamber 11 is approximately constant.

In the present embodiment, in the enlarged portion 14, the height of the flow channel (the cross-sectional area of the flow channel) enlarges rapidly. The height (Hb) at the enlargement change point may be as low as possible in order to reduce the distance to the electrodes as much as possible when the flow velocity of cells rapidly decreases due to the cells reaching the enlarged portion 14, and as a result, to further increase the cell capture ratio. The height (He) of the enlarged portion 14 may be determined as appropriate in accordance with the height (Hb) at the enlargement change point.

The comb electrodes 13 are formed on the upper surface of a substrate that constitutes the bottom surface of the flow channel chamber 11.

The present disclosure may relate to one or more embodiments below.
[1] A microdevice for capturing particles in a sample through dielectrophoresis, including:

an inlet;

an outlet; and

a flow channel including a flow channel chamber that connects the inlet and the outlet,

in which the flow channel chamber has an enlarged portion in which a cross-sectional area of a flow channel enlarges from the inlet toward the outlet, and

the flow channel chamber is provided with an electric field generation means disposed at least in the enlarged portion or the vicinity of the enlarged portion.
[2] The microdevice according to [1], in which in the enlarged portion, the cross-sectional area of the flow channel enlarges in a height direction with respect to a bottom surface of the flow channel chamber.
[3] The microdevice according to [1], in which in the enlarged portion, the cross-sectional area of the flow channel enlarges in a step-wise manner in a width direction with respect to a bottom surface of the flow channel chamber.
[4] The microdevice according to any of [1] to [3], in which a bottom surface of the flow channel chamber is a flat surface.
[5] The microdevice according to any of [1] to [4], in which the electric field generation means is disposed on a bottom surface of the flow channel chamber.
[6] A method for capturing particles in a sample, including:

generating an electric field for applying a dielectrophoretic force to particles, at least in an enlarged portion or the vicinity of the enlarged portion in the flow channel chamber having the enlarged portion in which a cross-sectional area of a flow channel enlarges from an upstream side toward a downstream side; and

introducing the sample containing particles into the flow channel chamber from the upstream side of the flow channel chamber.
[7] The capturing method according to [6], including applying a dielectrophoretic force to the particles in the enlarged portion.
[8] The capturing method according to [6] or [7], including applying a dielectrophoretic force to the particles from the upstream side of the enlarged portion to the enlarged portion.
[9] The capturing method according to any of [6] to [8], in which the flow channel chamber is a flow channel chamber of the microdevice according to any of [1] to [5].
[10] A method for capturing particles from a sample in a flow channel chamber of a microdevice,

the microdevice being the microdevice according to any of [1] to [5],

the method for capturing particles including causing the electric field generation means of the microdevice to generate an electric field; and

introducing the sample into the flow channel chamber from the inlet of the microdevice.
[11] The capturing method according to [10], in which the sample is introduced by introducing the sample in an amount that exceeds a capacity of the flow channel chamber.
[12] A method for concentrating particles in a sample, including capturing particles in a sample with the capturing method according to any of [6] to [11].
[13] The concentrating method according to [12] including introducing a collection liquid into the flow channel chamber and collecting the particles captured in the flow channel chamber from the flow channel chamber.
[14] A method for concentrating a sample, including:

capturing particles from the sample in the flow channel chamber with the capturing method according to any of [6] to [11]; and

introducing a collection liquid into the flow channel chamber and collecting the particles captured in the flow channel chamber from the flow channel chamber.
[15] A method for observing or analyzing particles, including:

capturing particles from the sample in the flow channel chamber with the capturing method according to any of [6] to [11]; and

observing or analyzing the particles captured in the flow channel chamber.
[16] A method for collecting particles in a sample, including:

capturing particles from the sample in the flow channel chamber with the capturing method according to any of [6] to [11]; and

introducing a collection liquid into the flow channel chamber and collecting the particles captured in the flow channel chamber from the flow channel chamber.
[17] A method for separating particles in a sample, including:

generating an electric field for applying a dielectrophoretic force to particles, at least in an enlarged portion or the vicinity of the enlarged portion in a flow channel chamber having the enlarged portion in which a cross-sectional area of a flow channel enlarges from an upstream side toward a downstream side; and

introducing a sample containing particles into the flow channel chamber from the upstream side of the flow channel chamber and separating a plurality of types of particles included in the sample.

### EXAMPLES

Hereinafter, the present disclosure will be further described using Examples. However, the present disclosure is not to be construed as limited to the following Examples.

### Example 1

Production of Microdevice

A microdevice shown in FIG. 1 was produced with a procedure below.
1) A pattern of electrodes was formed on an ITO substrate by wet etching.
2) The mold of a flow channel including a flow chamber was produced on a silicon wafer with SU-8 using lithography technology.
3) The flow channel was produced with PDMS using the above-described mold.
4) The surfaces of the ITO substrate having the patterned electrodes and the flow channel that was produced with PDMS were activated with oxygen plasma, and the mold was attached onto the ITO substrate such that the patterned electrodes faced the flow channel.

The flow chamber of the microdevice has a tapered portion which is extending in width and which is formed on the inlet side, and an enlarged portion in which the cross-sectional area of a flow channel enlarges in the height direction and which is formed on an approximately central portion of the flow channel chamber.

The height (Hb) of the portion that is located in front of the enlarged portion (the upstream side (the inlet side) of the enlarged portion) was approximately 50 μm, the height (He) of the enlarged portion was approximately 100 μm, and the volume of the flow channel chamber was approximately 4 μl.

Evaluation of Cell Capture Ratio

SNU-1 cells that were stained with Celltracker green were added to a dispersion liquid (a buffer for dielectrophoresis) below, and the liquid containing these cells was fed to a microdevice under conditions below, and the cells were captured. After the end of liquid feeding, the number of cells that were captured in the flow channel chamber was measured using a microscope, and the capture ratio was obtained by dividing the value by the number of added cells. The results are shown in Table 1 below.

### Feeding Conditions

Flow rate: 200 μL/min

Treatment amount of liquid: 200 μL

Applying conditions: 20 Vp-p, 1 MHz, sine wave, AC voltage

Cells: SNU-1 (human stomach cancer cells, living cells)

Dispersion liquid: 10 mM HEPES, 0.1 mM CaCl₂, 59 mM D-glucose, 236 mM sucrose, 0.2% BSA (approximately 40 μS/cm (4 mS/m))

### Comparative Examples 1 and 2

A microdevice was produced similarly to Example 1 and cells were captured similarly to Example 1 except that the enlarged portion was not provided and the height of the flow channel chamber was constant. The results are shown in Table 1 below.

TABLE 1

| | Example 1 | Comp. Ex. 1 | Comp. Ex. 2 |
|---|---|---|---|
| Enlarged portion | present | not present | not present |
| Height (μm) | 50→100 | 100 | 50 |
| Width (mm) | 7 | 7 | 7 |
| Length (mm) | 10 | 10 | 10 |
| Volume (μL) | 3.9 | 5.3 | 2.6 |
| Capture ratio (%) | 95 | 41 | 42 |

As shown in Table 1, the device of Example 1 having the enlarged portion captured cells at a capture ratio that was higher than that of the devices of Comparative Examples 1 and 2 having no enlarged portion. Also, as shown in Table 1, in the device of Example 1, the volume of the flow channel chamber was 3.9 μl, and thus the cells were significantly concentrated by introducing a cell liquid into the device of Example 1 such that the volume of the cell liquid was reduced to 1/50 or less that of the cell liquid before the introduction (treatment) (50-fold concentrated).

Although the experiment was performed with a treatment liquid amount of 200 μl in Example 1, it was possible to similarly perform treatment at a high capture ratio with a treatment liquid amount of 1 ml or more, and the cells were concentrated 250-fold or more with this method.

### Example 2

An experiment was performed similarly to Example 1 except that SNU-1 cells that were stained with Celltracker green were treated, fixed, and underwent membrane permeabilization treatment under treatment conditions below using paraformaldehyde (PFA) and Tween20 were used. The results are shown in Table 2 below and FIG. 2.

Fixation and Membrane Permeabilization Treatment Conditions
1. Fixation: 1% PFA (PBS solution) was used in reaction for 15 minutes at room temperature
2. Membrane permeabilization treatment: 0.175% Tween20 was used in reaction for 20 minutes at room temperature

### Comparative Examples 3 and 4

An experiment was performed similarly to Comparative Example 1 or 2 except that the cells that were fixed and underwent membrane permeabilization treatment in Example 2 were used. The results are shown in Table 2 below and FIG. 2.

TABLE 2

| | Example 2 | Comp. Ex. 3 | Comp. Ex. 4 |
|---|---|---|---|
| Enlarged portion | present | not present | not present |
| Height (μm) | 50→100 | 100 | 50 |
| Width (mm) | 7 | 7 | 7 |
| Length (mm) | 10 | 10 | 10 |
| Volume (μL) | 3.9 | 5.3 | 2.6 |
| Capture ratio (%) | 83 | 53 | 4 |

As shown in Table 2, the device of the Example 2 having the enlarged portion captured cells at a capture ratio that was higher than that of the devices of Comparative Examples 3 and 4 having no enlarged portion. Also, in the device of Example 2, the volume of the flow channel chamber was 3.9 μL, and thus the volume of the cell liquid was reduced to 1/50 or less that of the cell liquid before the introduction (treatment) by introducing the cell liquid into the device of Example 2, and as a result, the cells were easily concentrated significantly.

FIG. 2 is an image showing the distribution of the captured cells in Example 2 and Comparative Example 3. FIG. 2(a) is the image of Example 2, and FIG. 2(b) is the image of Comparative Example 3. FIGS. 2(c) and 2(d) show enlarged views of the region surrounded with white broken lines in FIGS. 2(a) and 2(b). White dots in FIGS. 2(a) to 2(d) show the captured cells. As shown in FIGS. 2(b) and 2(d), in the device of Comparative Example 3, locations at which the cells were captured were distributed. In contrast, as shown in FIGS. 2(a) and 2(c), in the device of Example 2, many cells were captured in the central portion of the device, that is, near the enlarged portion. That is, with the device of Example 2, cells were captured locally and the captured cells were observed easily.

### Example 3

An experiment was performed similarly to Example 1 except that a cell liquid containing cells that were fixed and underwent membrane permeabilization treatment in Example 2 was introduced at flow rates shown in Table 3 below into two types of microdevices having flow channel chambers provided with enlarged portion having different heights as shown in Table 3 below. The results are shown in Table 3 below.

TABLE 3

Capture ratio

| | | |
|---|---|---|
| Height (μm) | 50→100 | 50→300 |

| | | | |
|---|---|---|---|
| Flow rate | 50 | 108% | 116% |
| (μL/min) | 100 | 82% | 98% |
| | 200 | — | 77% |

As shown in Table 3, in all of the cases, use of the microdevice of the present disclosure that included the enlarged portion made it possible to capture cells at a high capture ratio exceeding 75%. Also, compared to a device provided with the enlarged portion having a 2-fold height (50 μm→100 μm), a device provided with the enlarged portion having a 6-fold height (50 μm→300 μm) captured cells with a higher flow rate at a higher capture ratio. In this manner, changing the height of the enlarged portion in accordance with a target treatment flow rate makes it possible to perform treatment at a higher flow rate.

### Comparative Example 5

1 mL of cell liquid containing cells that were fixed and underwent membrane permeabilization treatment in Example 2 was introduced into a microcentrifuge tube and centrifuged for 5 minutes at 200×g so as to collect the cells. The number of collected cells was measured and their collection ratio was obtained. As a result, the collection ratio was 22%.

### Example 4

Similarly to Example 1, 1 ml of cell liquid that was the same as that of Comparative Example 5 was concentrated with the microdevice of the present disclosure. As a result, the ratio of collecting cells that were collected in the device was 98% (treatment flow rate: 50 μL/min).

That is, it was confirmed that use of the microdevice of the present disclosure that included the enlarged portion made it possible to collect cells at a capture ratio that was higher than that of centrifugation.

### Example 5

Similarly to Example 1, 1 mL of cell liquid containing SW620 cells (human colon cancer cells) that were stained with Celltracker green was concentrated with the microdevice of the present disclosure (treatment flow rate: 20 μL/min). Next, 10 μl of PBS (−) was fed with a pipette from the outlet of the microdevice, and the cells that were captured in the microdevice were collected from the microdevice. The number of collected cells was measured using a microscope, and the collection ratio was obtained by dividing the value by the number of cells (rough number) in the cell liquid before liquid feeding. The results are shown in Table 4 below.

### Example 6

Similarly to Example 4, 1 ml of cell liquid containing SW620 cells that were treated under the conditions below was concentrated with the microdevice of the present disclosure, and the number of cells that were captured in the device was measured using a microscope. Next, 20 μl of PBS (−) was fed with a pipette from the outlet of the microdevice, and the cells that were captured in the microdevice were collected from the microdevice. The number of collected cells was measured using a microscope, and the collection ratio was obtained by dividing the value by the number of cells (rough number) in the cell liquid before liquid feeding. The results are shown in Table 4 below.

### Cell Treatment Conditions

1. Fixation: 2% PFA (PBS solution) was used in reaction for 15 minutes at room temperature
2. Membrane permeabilization treatment: 0.1% Tween20 was used in reaction for 15 minutes at room temperature
3. Staining: anti-cytokeratin antibody and Hoechst33342 were used in reaction for 15 minutes at room temperature

TABLE 4

| | Example 5 | Example 6 |
|---|---|---|
| Collection ratio | 110% | 98% |

As shown in Table 4, use of the microdevice of the present disclosure that included the enlarged portion made it possible to not only capture cells through dielectrophoresis and collect the cells in the device but also collect the cells that were captured in the device at a high collection ratio that was close to approximately 100% as a concentrated liquid after observation. Also, the reproducibility was high. With the collection method in which the total amount of the liquid in the device is sucked from the inlet, the cells were collected at a collection ratio as high as 85%.

Use of the microdevice of the present disclosure made it possible to easily collect cells while suppressing the loss of cells with a small amount of a collection liquid. That is, according to the microdevice of the present disclosure, cells were easily concentrated.

### Example 7

Similarly to Example 1, a cell liquid obtained by mixing SW620 cells that were treated under the conditions below and white blood cells that were treated under the conditions below was concentrated with the microdevice of the present disclosure (treatment flow rate: 20 μL/min).

### SW620 Cell Treatment Conditions

1. Fixation: 0.05% PFA (PBS solution) was used in reaction for 15 minutes at room temperature
2. Membrane permeabilization treatment: 0.4% Tween20 was used in reaction for 20 minutes at room temperature
3. Staining: anti-cytokeratin antibody and Hoechst33342 were used in reaction for 30 minutes at room temperature

### White Blood Cell Treatment Conditions

1. Fixation: 0.05% PFA (PBS solution) was used in reaction for 15 minutes at room temperature
2. Primary staining: antibody such as anti-CD45 was used in reaction for 15 minutes at room temperature
3. Secondary staining: secondary antibody for labeling and Hoechst33342 were used in reaction for 30 minutes at room temperature

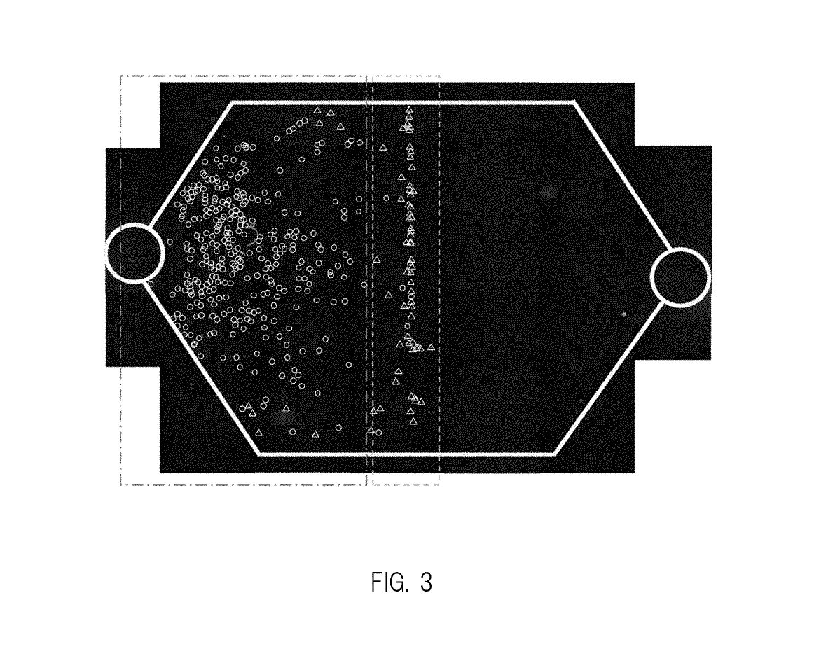

The results are shown in FIG. 3. FIG. 3 is an image showing the distribution of the captured cells in Example 7. In FIG. 3, the situation of the distribution of captured cells is schematically shown by surrounding cancer cells with triangles and white blood cells with circles.

In FIG. 3, the region of the upstream side of the enlarged portion (i.e. the region including the tapered portion) is shown by surrounding with long chain lines, and vicinity of the enlarged portion is shown by surrounding with broken line. As shown in FIG. 3, almost all of the white blood cells were captured on the upstream side (i.e., the inlet side) of the enlarged portion, and many cancer cells were captured in the vicinity of the enlarged portion. It is conceivable that this is because white blood cells received a small resistance from liquid flow and thus were captured on the upstream side of the enlarged portion, whereas cancer cells received a larger resistance than white blood cells from liquid flow, thus were not captured on the upstream side of the enlarged portion, and captured in the vicinity of the enlarged portion. In a case where a sample obtained by performing treatment such as staining on cells in a state in which both types of cells were mixed, a similar phenomenon was observed.

As the result of Example 7, according to the device of the present disclosure, it was suggested that in a case where a sample would contain a plurality of cells, the cells would be captured utilizing a difference in balance between a resistance of cells received from liquid flow and a dielectrophoretic force of cells received from an electric field such that positions at which those cells were captured were separated from each other.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A microdevice for capturing particles, the microdevice comprising:
an inlet;
an outlet; and
a flow channel comprising a flow channel chamber that connects the inlet and the outlet,
wherein the flow channel chamber has an enlarged portion in which a cross-sectional area of a flow channel enlarges, and
the flow channel chamber is provided with an electric field generation means disposed at least in the enlarged portion or the vicinity of the enlarged portion.

2. The microdevice according to claim 1,
wherein in the enlarged portion, the cross-sectional area of the flow channel enlarges in a height direction with respect to a bottom surface of the flow channel chamber.

3. The microdevice according to claim 1,
wherein in the enlarged portion, the cross-sectional area of the flow channel enlarges in a step-wise manner in a width direction with respect to a bottom surface of the flow channel chamber.

4. The microdevice according to claim 1,
wherein a bottom surface of the flow channel chamber is a flat surface.

5. The microdevice according to claim 1,
wherein the electric field generation means is disposed on a bottom surface of the flow channel chamber.

6. The microdevice according to claim 1,
wherein the electric field generation means comprises a counter electrode for dielectrophoresis.

7. A method for capturing particles from a sample in a flow channel chamber of the microdevice of claim 1, the method comprising:
causing the electric field generation means of the microdevice to generate an electric field; and
introducing the sample into the flow channel chamber from the inlet of the microdevice.

8. The method according to claim 7,
comprising introducing the sample in an amount that exceeds a capacity of the flow channel chamber.

9. The method according to claim 7,
wherein in the enlarged portion, the cross-sectional area of the flow channel enlarges in a height direction with respect to a bottom surface of the flow channel chamber.

10. The method according to claim 7,
wherein in the enlarged portion, the cross-sectional area of the flow channel enlarges in a step-wise manner in a width direction with respect to a bottom surface of the flow channel chamber.

11. The method according to claim 7,
wherein a bottom surface of the flow channel chamber is a flat surface.

12. The method according to claim 7,
wherein the electric field generation means is disposed on a bottom surface of the flow channel chamber.

13. The method according to claim 7,
wherein the sample is a human blood sample.

14. A method for concentrating a sample, the method comprising:
capturing particles from the sample in the flow channel chamber with the method according to claim 7;
introducing a collection liquid into the flow channel chamber; and
collecting the particles captured in the flow channel chamber from the flow channel chamber.

15. The method according to claim 14,
wherein in the enlarged portion, the cross-sectional area of the flow channel enlarges in a height direction with respect to a bottom surface of the flow channel chamber.

16. The method according to claim 14,
wherein in the enlarged portion, the cross-sectional area of the flow channel enlarges in a step-wise manner in a width direction with respect to a bottom surface of the flow channel chamber.

17. The method according to claim 14,
wherein a bottom surface of the flow channel chamber is a flat surface.

18. The method according to claim 14,
wherein the electric field generation means is disposed on a bottom surface of the flow channel chamber.

19. The method according to claim 12,
wherein the sample is a human blood sample.

20. A method for separating particles in a sample, the method comprising:
generating an electric field for applying a dielectrophoretic force to particles, at least in an enlarged portion or the vicinity of the enlarged portion in a flow channel chamber having the enlarged portion in which a cross-sectional area of a flow channel enlarges from an upstream side toward a downstream side;
introducing a sample containing particles into the flow channel chamber from the upstream side of the flow channel chamber; and
separating a plurality of types of particles included in the sample.
